(19) United States
(12) Patent Application Publication
(10) Pub. No.: US 2024/0424589 A1
(43) Pub. Date: Dec. 26, 2024

(54) METHOD AND APPARATUS FOR EVALUATING WELDING ARC STABILITY, DEVICE AND MEDIUM

(71) Applicant: Foshan University, Foshan (CN)

(72) Inventors: Kuanfang He, Foshan (CN); Rongyu Zhou, Foshan (CN); Mian Jiang, Foshan (CN); Hui Xiao, Foshan (CN); Chuan Liu, Foshan (CN); Kai Wang, Foshan (CN); Qinghua Lu, Foshan (CN); Te Hu, Foshan (CN)

(73) Assignee: Foshan University, Foshan, GU (CN)

(21) Appl. No.: 18/747,869

(22) Filed: Jun. 19, 2024

(30) Foreign Application Priority Data
Jun. 20, 2023 (CN) 202310735776.7

(51) Int. Cl. B23K 9/095

(52) U.S. Cl. CPC B23K 9/0953; B23K 9/0956

(57) ABSTRACT

Provided is a method and an apparatus for evaluating welding arc stability, a device and a medium, and belongs to the technical field of welding. The method includes: determining a plurality of indexes for evaluating arc stability, reference index values of each index and a number of evaluation levels according to sample acoustic emission signals; determining reference membership degrees of different indexes to different evaluation levels according to the reference index values of each index; determining an index value to be measured of each index according to the acquired acoustic emission signals to be measured; determining the membership degree to be measured of each index according to the index value to be measured of each index; and evaluating a level of the arc stability according to the membership degrees to be measured and the reference membership degrees.

### CROSS-REFERENCE TO RELATED APPLICATION

This patent application claims the benefit and priority of Chinese Patent Application No. 202310735776.7 filed with the China National Intellectual Property Administration on Jun. 20, 2023, the disclosure of which is incorporated by reference herein in its entirety as part of the present disclosure.

### TECHNICAL FIELD

The present disclosure relates to the technical field of welding, in particular to a method and an apparatus for evaluating welding arc stability, a device and a medium.

### BACKGROUND

In the welding process of DP-MIG (double pulse-melt inert-gas) of aluminum alloys, when the arc state is unstable due to the disturbance of materials, technology and environment, a molten pool is in a state of oscillation, a liquid metal is unevenly distributed, and the liquid impacts the molten pool, which easily leads to the fluctuation of the molten pool, and results in defects such as blowholes, cracks and splashes in the weld forming process, and even processing failure. These seriously affects the processing quality and the production efficiency of an aluminum alloy welding structure. In order to effectively suppress the defects in the welding process of DP-MIG of aluminum alloys and ensure the quality of the welding structure, it is necessary to effectively evaluate the welding arc stability of DP-MIG.

At present, the stable state of the arc is judged according to the characteristics of the current amplitude and the current waveform slope by detecting the current when the arc occurs. However, because the welding process of DP-MIG of aluminum alloys is a complex and changeable physical process, electric signals detected in this way cannot fully reflect the complex physical welding process, so that the judgment result is limited. This may also lead to misjudgment, so that it is difficult to ensure the quality of the welding structure.

### SUMMARY

In view of the above problems, the present disclosure has been put forward to provide a method and an apparatus for evaluating welding arc stability, a device and a medium, which can overcome or at least partially solve the above problems, and can evaluate the level of the arc stability according to the reference membership degrees of different arc stability evaluation indexes to different evaluation levels determined by sample acoustic emission signals and the membership degrees to be measured of each index of the acoustic emission signals to be measured. The method reflects a complex physical welding process through the detected acoustic emission signals generated in the welding process, and then evaluates the level of the arc stability by means of the membership degrees, so that the evaluation result is more accurate. The welding process is adjusted with reference to the evaluation level, which can effectively suppress the defects in the welding process and improve the quality of the welding structure.

In a first aspect, the present disclosure provides a method for evaluating welding arc stability, where the method includes:
determining a plurality of indexes for evaluating arc stability, reference index values of each index and a number of evaluation levels according to sample acoustic emission signals;
determining reference membership degrees of different indexes to different evaluation levels according to the reference index values of each index;
acquiring acoustic emission signals to be measured;
determining an index value to be measured of each index according to the acoustic emission signals to be measured;
determining a membership degree to be measured of each index according to the index value to be measured of each index; and
evaluating a level of the arc stability according to membership degrees to be measured and the reference membership degrees.

Optionally, evaluating the level of the arc stability according to the membership degrees to be measured and the reference membership degrees includes:
determining closenesses of the acoustic emission signals to be measured to each evaluation level according to the membership degrees to be measured and the reference membership degreses;
evaluating the level of the arc stability according to the closenesses.

Optionally, determining the closenesses of the acoustic emission signals to be measured to each evaluation level according to the membership degrees to be measured and the reference membership degrees includes:
determining a weight of each index;
determining a Hamming distance of each evaluation level according to weights, the membership degrees to be measured and the reference membership degrees;
determining the closenesses of the acoustic emission signals to be measured to each evaluation level according to the Hamming distance of each evaluation level.

Optionally, determining the Hamming distance of each evaluation level according to the weights, the membership degrees to be measured and the reference membership degrees includes:
determining the Hamming distance according to the following formula:

$${D}_{i} ( {μ}_{B} , {μ}_{{A}_{i}} ) = m * {\sum }_{k = 1}^{m} [ \vert {μ}_{B} ( {X}_{K} ) - {μ}_{{A}_{i}} ( {X}_{K} ) \vert * {W}_{k} ] ;$$

where Dᵢ denotes the Hamming distance of an i-th level, m denotes a number of indexes, i denotes a number of the evaluation levels, μ_{B} (Xₖ) denotes the membership degree to be measured of a k-th index, μ_{A}_{ᵢ} (Xₖ) denotes the reference membership degree of the k-th index to the i-th level, and Wₖ denotes the weight of the k-th index.

Optionally, determining the closenesses of the acoustic emission signals to be measured to each evaluation level according to the Hamming distance of each evaluation level includes:
determining the closenesses according to the following formula:

$${σ}_{i} ( {μ}_{B} , {μ}_{{A}_{i}} ) = 1 - \frac{{D}_{i} ( {μ}_{B} , {μ}_{{A}_{i}} )}{m}$$

where σᵢ denotes the closeness of the i-th level, Dᵢ denotes the Hamming distance of the i-th level, m denotes a number of indexes, μ_{B} denotes the membership degrees to be measured, and μ_{A}_{ᵢ} denotes the reference membership degrees under the i-th level.

Optionally, determining the plurality of indexes for evaluating arc stability according to the sample acoustic emission signals includes:
determining the plurality of indexes for evaluating arc stability by analyzing the sample acoustic emission signals in time domain, frequency domain and time-frequency domain.

Optionally, there are four evaluation levels including good stability, average stability, poor stability and extremely poor stability.

In a second aspect, the present disclosure provides an apparatus for evaluating welding arc stability, where the apparatus includes:
a first determining module, which is configured to determine a plurality of indexes for evaluating arc stability, reference index values of each index and a number of evaluation levels according to sample acoustic emission signals;
a second determining module, which is configured to determine reference membership degrees of different indexes to different evaluation levels according to the reference index values of each index;
an acquiring module, which is configured to acquire acoustic emission signals to be measured;
a third determining module, which is configured to determine an index value to be measured of each index according to the acoustic emission signals to be measured;
a fourth determining module, which is configured to determine a membership degree to be measured of each index according to the index value to be measured of each index; and
an evaluating module, which is configured to evaluate a level of the arc stability according to membership degrees to be measured and the reference membership degrees.

Optionally, the evaluating module includes:
a closeness determining unit, which is configured to determine the closenesses of the acoustic emission signals to be measured to each evaluation level according to the membership degrees to be measured and the reference membership degrees;
a level evaluation unit, which is configured to evaluate the level of the arc stability according to the closenesses.

Optionally, the closeness determining unit is further configured to:
determine a weight of each index;
determine a Hamming distance of each evaluation level according to the weights, the membership degrees to be measured and the reference membership degrees;
determine the closenesses of the acoustic emission signals to be measured to each evaluation level according to the Hamming distance of each evaluation level.

Optionally, the closeness determining unit is further configured to:
determine the Hamming distances according to the following formula:

$${D}_{i} ( {μ}_{B} , {μ}_{{A}_{i}} ) = m * {\sum }_{k = 1}^{m} [ \vert {μ}_{B} ( {X}_{K} ) - {μ}_{{A}_{i}} ( {X}_{K} ) \vert * {W}_{k} ]$$

where Dᵢ denotes the Hamming distance of an i-th level, m denotes the number of indexes, i denotes the number of the evaluation levels, μ_{B} (Xₖ) denotes the membership degree to be measured of a k-th index, μ_{A}_{ᵢ}(Xₖ) denotes the reference membership degree of the k-th index to the i-th level, and Wₖ denotes the weight of the k-th index.

Optionally, the closeness determining unit is further configured to:
determine the closenesses according to the following formula:

$${σ}_{i} ( {μ}_{B} , {μ}_{{A}_{i}} ) = 1 - \frac{{D}_{i} ( {μ}_{B} , {μ}_{{A}_{i}} )}{m}$$

where σᵢ denotes the closeness of the i-th level, Dᵢ denotes the Hamming distance of the i-th level, m denotes the number of indexes, μ_{B} denotes the membership degrees to be measured, and μ_{A}_{ᵢ} denotes the reference membership degrees under the i-th level.

Optionally, the first determining module is further configured to:
determine a plurality of indexes for evaluating arc stability by analyzing the sample acoustic emission signals in time domain, frequency domain and time-frequency domain.

Optionally, there are four evaluation levels including good stability, average stability, poor stability and extremely poor stability.

In a third aspect, the present disclosure provides an electronic device, including a memory and a processor, where the memory and the processor are in communication connection with each other, computer instructions are stored in the memory, and the processor executes the method according to the first aspect by executing the computer instructions.

In a fourth aspect, the present disclosure provides a computer-readable storage medium, where the computer-readable storage medium stores computer instructions for causing the computer to execute the method according to the first aspect.

The technical solution provided in the embodiment of the present disclosure has at least the following technical effects or advantages.

The embodiment of the present disclosure provides a method and an apparatus for evaluating welding arc stability, a device and a medium, in which a plurality of indexes for evaluating arc stability, reference index values of each index and a number of evaluation levels are determined according to sample acoustic emission signals, that is to say, a complex physical welding process is reflected through acoustic emission signals; reference membership degrees of different indexes to different evaluation levels are determined according to the reference index values of each index, and the degree to which an index belongs to an evaluation level can be accurately determined through the membership degree; an index value to be measured of each index is determined according to the acquired acoustic emission signals to be measured; a membership degree to be measured of each index is determined according to the index value to be measured of each index; and a level of the arc stability is evaluated according to membership degrees to be measured and the reference membership degrees. The method reflects a complex physical welding process through the detected acoustic emission signals generated in the welding process, and then evaluates the level of the arc stability by means of the membership degrees, so that the evaluation result is more accurate. The welding process is adjusted with reference to the evaluation level, which can effectively suppress the defects in the welding process and improve the quality of the welding structure.

The above description is only an overview of the technical solution of the present disclosure, which can be implemented according to the content of the specification in order to clearly understand the technical means of the present disclosure. Moreover, in order to make the above and other purposes, features and advantages of the present disclosure more obvious and understandable, the detailed description of the embodiments of the present disclosure is taken as an example.

### BRIEF DESCRIPTION OF THE DRAWINGS

Various other advantages and benefits will become apparent to those skilled in the art when reading the following detailed description of the preferred embodiments. The drawings are only used for the purpose of illustrating the preferred embodiment, rather than considered as limiting the present disclosure. Moreover, the same parts are denoted by the same reference numerals throughout the drawings. In the drawings:

FIG. 1 is a schematic structural diagram of an acoustic emission signal testing apparatus according to an embodiment of the present disclosure.

FIG. 2 is a schematic diagram of a double-pulse waveform according to an embodiment of the present disclosure.

FIG. 3 is a waveform diagram of an acoustic emission signal of Experiment 1 according to an embodiment of the present disclosure.

FIG. 4 is a waveform diagram of an acoustic emission signal of Experiment 2 according to an embodiment of the present disclosure.

FIG. 5 is a flowchart of a method for evaluating welding arc stability according to an embodiment of the present disclosure.

FIG. 6 is a waveform diagram of an acoustic emission signal of Experiment 1 after filtering processing according to an embodiment of the present disclosure.

FIG. 7 is a waveform diagram of an acoustic emission signal of Experiment 2 after filtering processing according to an embodiment of the present disclosure.

FIG. 8 is a waveform comparison diagram of an acoustic emission signal and an arc current signal of Experiment 1 according to an embodiment of the present disclosure.

FIG. 9 is an enlarged waveform diagram in a dashed box in FIG. 8.

FIG. 10 is a waveform comparison diagram of an acoustic emission signal and an arc current signal of Experiment 2 according to an embodiment of the present disclosure.

FIG. 11 is an enlarged waveform diagram in a dashed box in FIG. 10.

FIG. 12 is a spectrum diagram of an acoustic emission signal of Experiment 1 according to an embodiment of the present disclosure.

FIG. 13 is a spectrum diagram of an arc current signal of Experiment 1 according to an embodiment of the present disclosure.

FIG. 14 is a spectrum diagram of an acoustic emission signal of Experiment 2 according to an embodiment of the present disclosure.

FIG. 15 is a spectrum diagram of an arc current signal of Experiment 2 according to an embodiment of the present disclosure.

FIG. 16 is a structural block diagram of evaluating welding arc stability according to an embodiment of the present disclosure.

### DETAILED DESCRIPTION OF THE EMBODIMENTS

In order to make the purpose, the technical solution and the advantages of the present disclosure more clear, the embodiment of the present disclosure will be further described in detail with reference to the attached drawings.

Before introducing the evaluation of welding arc stability according to an embodiment of the present disclosure in detail, the application scenes involved in the embodiment of the present disclosure are briefly introduced.

In the welding process of DP-MIG of aluminum alloys, when the arc state is unstable due to the disturbance of materials, technology and environment, a molten pool is in a state of oscillation, a liquid metal is unevenly distributed, and the liquid impacts the molten pool, which easily leads to the fluctuation of the molten pool, and results in defects such as blowholes, cracks and splashes in the weld forming process, and even processing failure. This seriously affects the processing quality and the production efficiency of an aluminum alloy welding structure. In order to effectively suppress the defects in the welding process of DP-MIG of aluminum alloys and ensure the quality of the welding structure, it is necessary to effectively evaluate the welding arc stability of DP-MIG.

At present, the stable state of the arc is judged according to the characteristics of the current amplitude and the current waveform slope by detecting the current when the arc occurs. However, because the welding process of DP-MIG of aluminum alloys is a complex and changeable physical process, electric signals detected in this way cannot fully reflect the complex physical welding process, so that the judgment result is limited. This may also lead to a misjudgment, so that it is difficult to ensure the quality of the welding structure.

By researching the welding process of DP-MIG of aluminum alloys, it is found that acoustic emission (AE) signals generated in the welding process are a multi-source signal. The generation of arc pulses, the melting of metals, the solidification of molten pools and the phase transformation of welding seams may be effective acoustic emission sources, which carry a large amount of information about the welding process and have a high research value for on-line monitoring of the welding quality. As one of the companions in the welding process, the acoustic emission signals of the welding arc can effectively reflect the arc stability in the welding process.

The acoustic emission signals belong to a high-frequency elastic stress wave signal, which are converted into electrical signals after being amplified by sensors and front devices. The signals consist of multi-mode waves. Each mode consists of broadband frequency component waves, and has the transient and multi-frequency characteristics, which is a non-stationary random signal.

Therefore, on the basis of effectively extracting the arc acoustic emission signals, the present disclosure studies the sensitive reaction of the acoustic emission signals to the arc stability, and can evaluate the level of the arc stability according to the reference membership degrees of different arc stability evaluation indexes to different evaluation levels determined by sample acoustic emission signals and the membership degree to be measured of each index of the acoustic emission signals to be measured. The method reflects a complex physical welding process through the detected acoustic emission signals generated in the welding process, and then evaluates the level of the arc stability by means of the membership degree, so that the evaluation result is more accurate. The welding process is adjusted with reference to the evaluation level, which can effectively suppress the defects in the welding process and improve the quality of the welding structure.

Next, an implementation environment involved in the evaluation of welding arc stability provided by an embodiment of the present disclosure is briefly introduced.

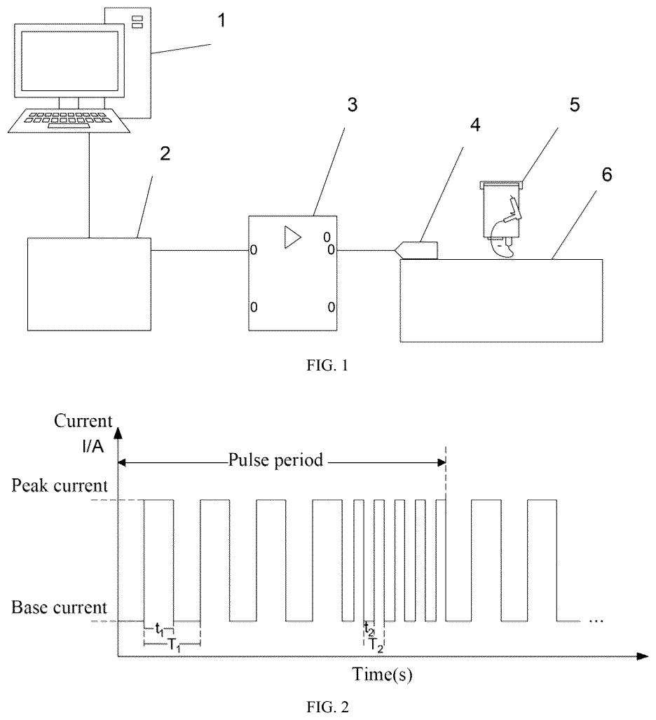

FIG. 1 is a schematic structural diagram of an acoustic emission signals testing apparatus according to an embodiment of the present disclosure. As shown in FIG. 1, the testing apparatus includes a computer 1, an acoustic emission mainframe 2, a preamplifier 3, an acoustic emission sensor 4, an arc welding gun 5 and a workpiece platform 6.

In this embodiment, the workpiece platform 6 is configured to place the workpiece to be welded. The arc welding gun 5 is configured to weld the workpiece to be welded. The acoustic emission sensor 4 is configured to detect the acoustic emission signals generated in the welding process. The preamplifier 3 is configured to amplify the detected acoustic emission signals. The acoustic emission mainframe 2 is configured to collect the amplified acoustic emission signals and transmit the collected amplified acoustic emission signals to the computer 1. The computer 1 is used to process and analyze the amplified acoustic emission signals.

Considering that the frequency of the arc acoustic emission signals is mainly concentrated in the frequency band of 22.5 to 103.5 kHz, because the acoustic emission signals are weak and have the characteristics of energy attenuation during propagation, it is usually necessary to use an amplifier to amplify the signal energy after the acoustic emission signals are converted into electrical signals. The preamplifier 3 can be a fixed gain amplifier with a bandwidth of 10 kHz to 3 MHz and a gain of 40±1 dB.

There are many factors affecting the welding arc stability of DP-MIG of aluminum alloys, in which the welding process parameters account for a high proportion. In this embodiment, the welding process can use a double-pulse waveform. FIG. 2 is a schematic diagram of a double-pulse waveform according to an embodiment of the present disclosure. Two process parameters are determined by the double-pulse waveform shown in FIG. 2. The welding experimental parameters of DP-MIG of aluminum alloys are formed at different welding speeds, as shown in FIG. 2. The duty cycle is

$$\frac{{t}_{1}}{{T}_{1}} = \frac{{t}_{2}}{{T}_{2}} = 50 \% .$$

The specific welding experimental parameters are shown in Table 1 below.

TABLE 1

| | | | | Peak | Base | | Pulse |
|---|---|---|---|---|---|---|---|
| Exper- | Welding | Peak | Base | volt- | volt- | Duty | fre- |
| iment | speed | current | current | age | age | cycle | quency |
| number | (mm/s) | (A) | (A) | (V) | (V) | (%) | (Hz) |
| 1 | 2 | 100 | 60 | 22 | 18 | 50 | 1.36 |
| 2 | 4 | 100 | 60 | 22 | 18 | 50 | 0.7 |

For example, through the testing apparatus in FIG. 1, two groups of welding preliminary research experiments are conducted using the welding experimental parameters in Table 1. The acoustic emission signals generated in the welding process are collected as the acoustic emission signals for preliminary research. Specifically, the used workpiece samples can be 6061 aluminum alloys, and the workpieces have a size of 250 mm×200 mm×5 mm. The hardness of the samples measured by the HR150A Rockwell Hardness Tester is 34.0HRC. The flow rate of shielding gas can be 15 L/min. The welding wire is a model of er5356, has an elongation of 15 mm and a diameter of φ 1.2 mm.

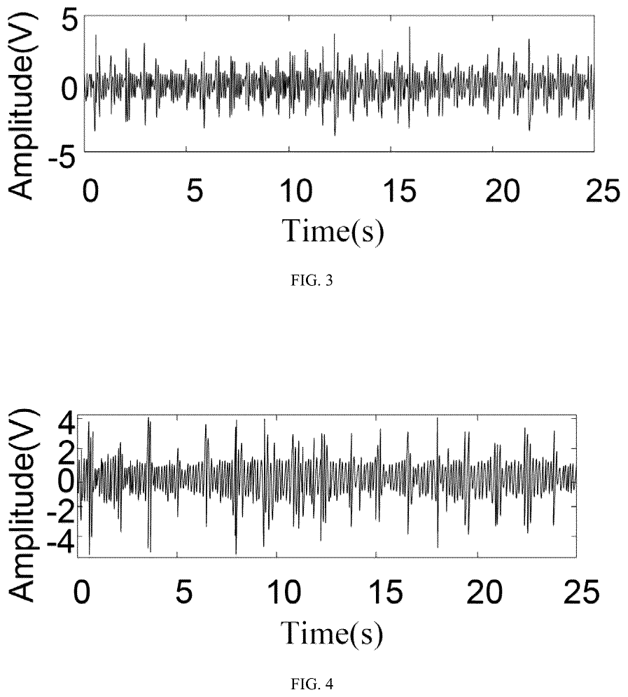

FIG. 3 is a waveform diagram of an acoustic emission signal of Experiment 1 according to an embodiment of the present disclosure, and FIG. 4 is a waveform diagram of an acoustic emission signal of Experiment 2 according to an embodiment of the present disclosure. As shown in FIGS. 3 and 4, the acoustic emission signals of the two groups of preliminary research experiments have certain periodicity. The periodicity of the acoustic emission signal waveform changes with the change of pulse frequency. The increase of the pulse frequency makes the waveform pulse denser in a certain period of time. The waveform frequencies of the acoustic emission signals collected in the two groups of experiments are the same as the pulse frequency set in Experimental parameters, which shows that it is feasible to understand the stability of a welding arc by researching the acoustic emission signals in the welding process.

After introducing the application scene and the implementation environment involved in the embodiment of the present disclosure, the method for evaluating welding arc stability according to an embodiment of the present disclosure will be introduced in detail with reference to the attached drawings.

FIG. 5 is a flowchart of a method for evaluating welding arc stability according to an embodiment of the present disclosure. As shown in FIG. 5, the method includes the following steps:

Step S510: a plurality of indexes for evaluating arc stability, reference index values of each index and a number of evaluation levels are determined according to sample acoustic emission signals.

In this embodiment, the sample acoustic emission signals can be acquired through a plurality of welding experiments. The plurality of welding experiments can include welding of various welding seam shapes, such as unshaped welding seams, fish-scale welding seams, welding seams with hump defects, discontinuous welding seams and welding seams with a good surface, etc., in order to obtain more comprehensive sample data. At the same time, the welding seam shaped results of the actually welded assembly are marked and saved, which can be used in the following steps.

Optionally, Step S510 includes:
determining a plurality of indexes for evaluating arc stability by analyzing the sample acoustic emission signals in time domain, frequency domain and time-frequency domain.

In this embodiment, the acoustic emission signals of two groups of preliminary research experiments in the above implementation environment can be analyzed in time domain, frequency domain and time-frequency domain. When the analysis results show that the acoustic emission signals can be determined to be used to reflect the arc stability by the methods of analysis in time domain, frequency domain and time-frequency domain, a large number of experiments can be carried out to acquire a large number of sample acoustic emission signals.

A first step is time domain analysis.

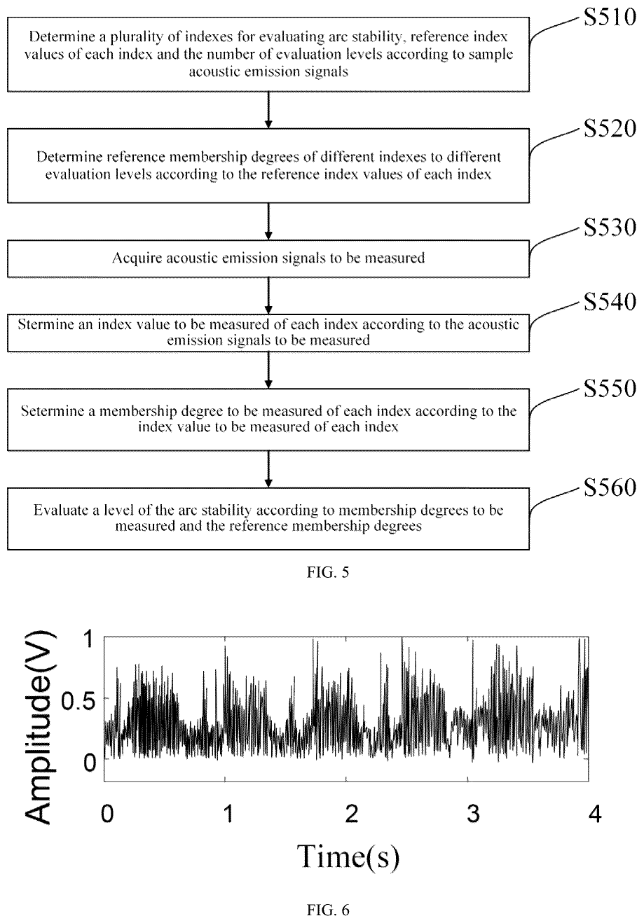

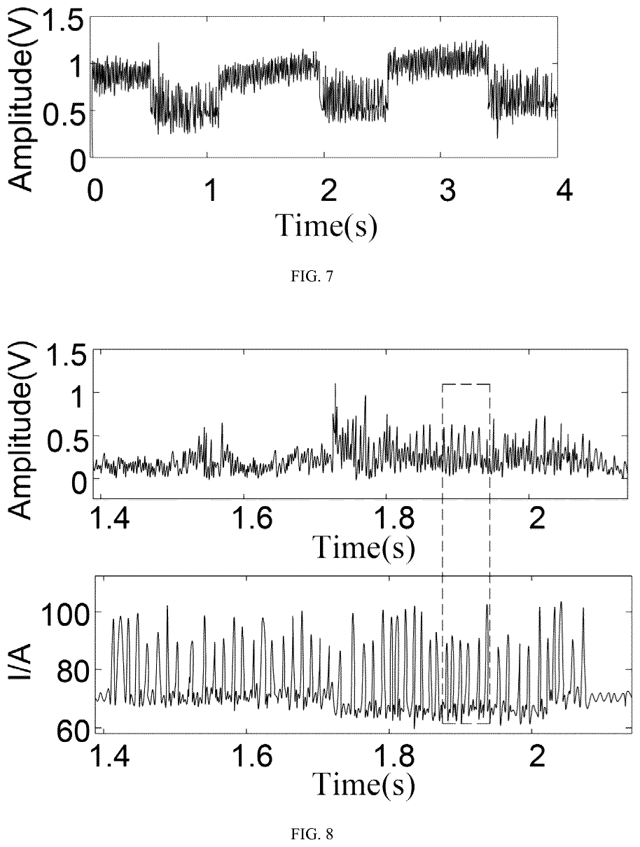

In this embodiment, the acoustic emission signals of FIGS. 1 and 2 are filtered. FIG. 6 is a waveform diagram of an acoustic emission signal of Experiment 1 after filtering processing according to an embodiment of the present disclosure. FIG. 7 is a waveform diagram of an acoustic emission signal of Experiment 2 after filtering processing according to an embodiment of the present disclosure. It can be more clearly observed from FIGS. 6 and 7 that the acoustic emission signals of the two groups of experiments both have certain periodicity.

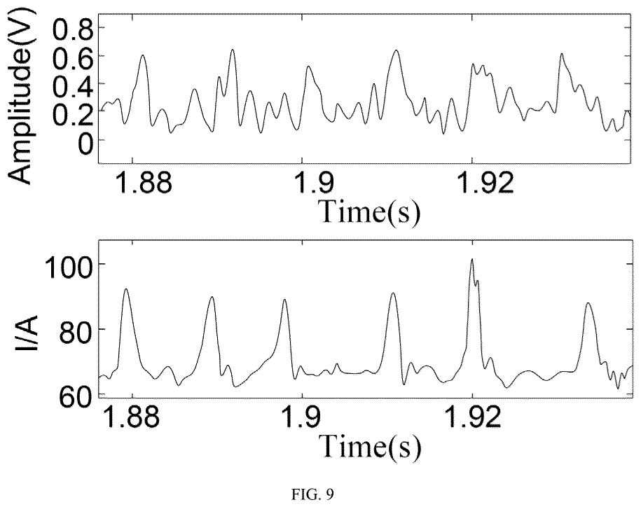

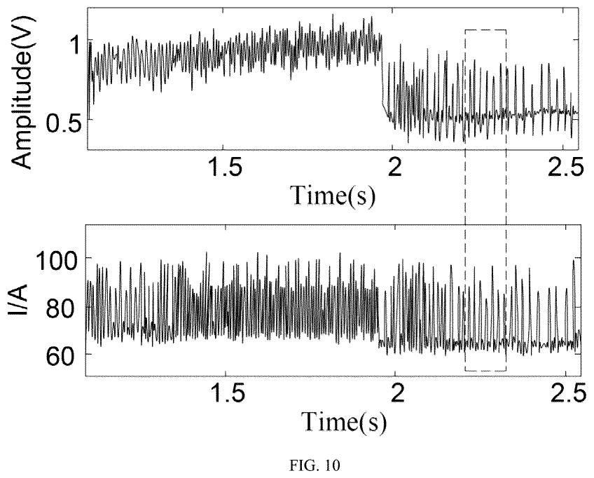

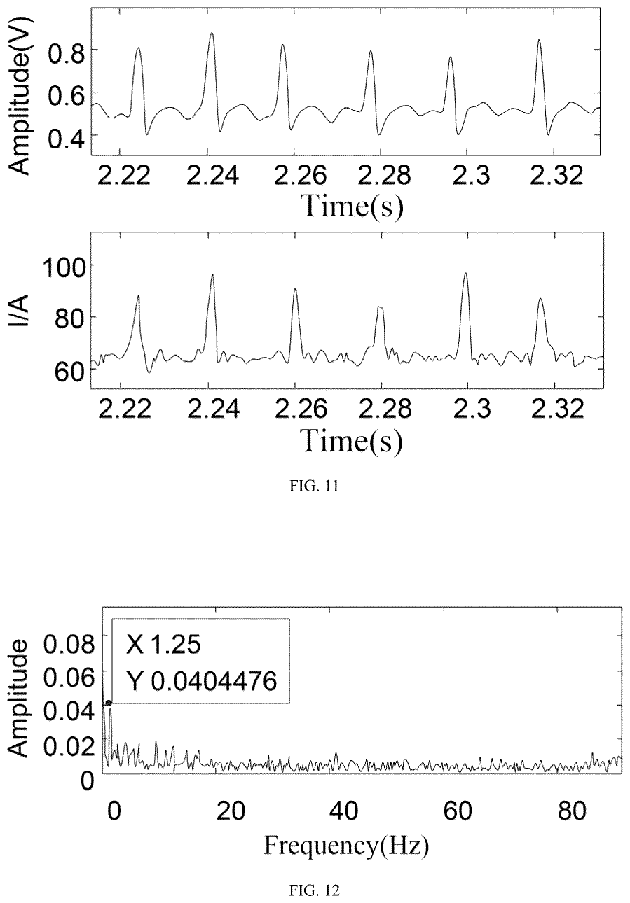

FIG. 8 is a waveform comparison diagram of an acoustic emission signal and an arc current signal of Experiment 1 according to an embodiment of the present disclosure. FIG. 9 is an enlarged waveform diagram in a dashed box in FIG. 8. FIG. 10 is a waveform comparison diagram of an acoustic emission signal and an arc current signal of Experiment 2 according to an embodiment of the present disclosure. FIG. 11 is an enlarged waveform diagram in a dashed box in FIG. 10. FIGS. 8 to 11 show the detailed comparison of arc acoustic emission signals and arc current signals. It is observed that the periodic alternating change of acoustic emission signals in time domain obtained by the resonance demodulation method is consistent with the time domain waveform change law of the arc current signals.

Therefore, through the detailed analysis of the acoustic emission signal waveforms in time domain, it is further confirmed that it is feasible to understand the stability of the welding arc by researching the acoustic emission signals in the welding process.

In this embodiment, it is also necessary to calculate and analyze the data of the acoustic emission signals to get more accurate data support, so as to determine the indexes that can be used to evaluate arc stability. Specifically, seven time-domain statistical characteristic parameters such as a mean, a peak, a peak-to-peak value, a root mean square, a variance, a mean square value and a kurtosis coefficient can be selected for analysis. For example, it is assumed that the sample acoustic emission signal be xᵢ (i=1, 2, 3, . . . , Nₛ), and the definition formula of each time-domain statistical characteristic parameter is shown in Table 2:

TABLE 2

| characteristic | | characteristic | |
|---|---|---|---|
| parameter | definition | parameter | definition |
| mean | $M = \frac{1}{{N}_{s}} {\sum }_{i = 1}^{{N}_{s}} {x}_{i}$ | variance | ${σ}^{2} = \frac{1}{{N}_{s}} {\sum }_{i = 1}^{{N}_{s}} {( {x}_{i} - \overline{x} )}^{2}$ |
| peak | p = max\|xᵢ\| | mean square value | ${M}_{D} = \frac{1}{{N}_{s}} {\sum }_{i = 1}^{{N}_{s}} {x}_{i}^{2}$ |
| peak-to-peak value | Pₖ = max (xᵢ) − min(xᵢ) | kurtosis coefficient | $K = \frac{1}{{N}_{s}} {\sum }_{i = 1}^{{N}_{s}} {( \frac{{x}_{i} - \overline{x}}{σ} )}^{4}$ |
| root mean square | $R = \sqrt{\frac{1}{{N}_{s}} {{\sum }^{{N}_{s}}}_{i = 1} {x}_{i}^{2}}$ | / | / |

The x̅ in variance formula in Table 2 is the mean value M. The eigenvalues of seven time-domain characteristic parameters, such as the mean, the peak, the peak-to-peak value, the root mean square, the variance, the mean square value and the kurtosis coefficient, which are calculated by the formulas defined in Table 2, are saved for analysis and use in the subsequent steps.

The second step is frequency domain analysis.

In this embodiment, the accuracy of frequency domain analysis is higher than that of time domain analysis, and the common method is to convert the signals from time domain to frequency domain by FFT (fast Fourier transform).

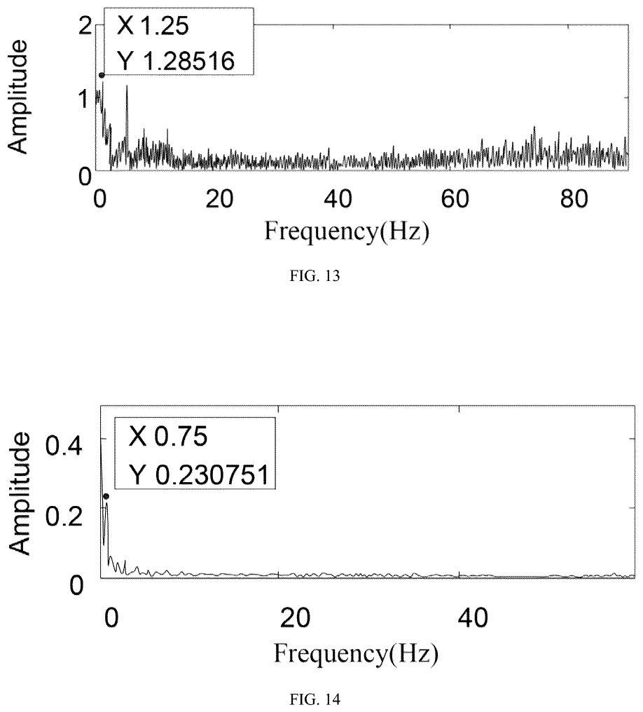

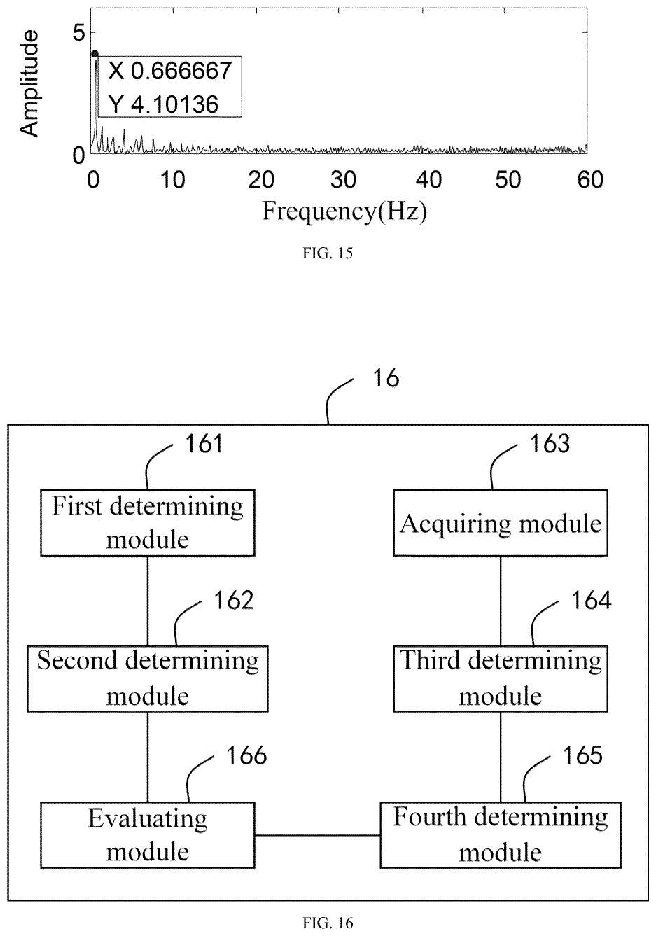

FIG. 12 is a spectrum diagram of an acoustic emission signal of Experiment 1 according to an embodiment of the present disclosure. FIG. 13 is a spectrum diagram of an arc current signal of Experiment 1 according to an embodiment of the present disclosure. FIG. 14 is a spectrum diagram of an acoustic emission signal of Experiment 2 according to an embodiment of the present disclosure. FIG. 15 is a spectrum diagram of an arc current signal of Experiment 2 according to an embodiment of the present disclosure. As shown in FIGS. 12 to 15, the arc acoustic emission signals and the current signals have the same spectrum distribution law. The energy of the acoustic emission signal obtained in Experiment 1 is concentrated at 1.25 Hz, which is consistent with the energy concentration point of the current. The energy of the acoustic emission signal obtained in Experiment 2 is concentrated at 0.75 Hz, which is close to the energy concentration point of the current.

Therefore, by comparing the spectrums of the acoustic emission signals and the current signals, it is concluded that the acoustic emission signals can reflect the changes of the arc energy in the welding process. There is good correspondence between the waveforms of the currents and the arc acoustic emission signals.

In this embodiment, it is also necessary to calculate the characteristic parameters of their frequency domain signals to get more accurate data support, so as to determine the indexes that can be used to evaluate arc stability.

Specifically, five frequency domain characteristic parameters, such as an average amplitude, a root mean square frequency, a center frequency, a kurtosis frequency and a standard deviation frequency, can be selected for analysis. For example, the sample acoustic emission signals can be assumed as {Xᵢ}ᵢ^{N}=1. The spectrum signals X(k) can be obtained by FFT. According to the spectrum signals X(k), the definition formulas of frequency domain characteristic parameters are determined, as shown in Table 3.

TABLE 3

| characteristic | | characteristic | |
|---|---|---|---|
| parameters | definition | parameters | definition |
| average amplitude | ${F}_{1} = \frac{1}{N} {\sum }_{k = 1}^{N} X ( k )$ | root mean square frequency | ${F}_{4} = \sqrt{\frac{1}{{\sum }_{k = 1}^{N} X ( k )} {{\sum }_{k = 1}}^{N} {f}_{k}^{2} X ( k )}$ |
| center frequency | ${F}_{2} = \frac{1}{{\sum }_{k = 1}^{N} X ( k )} {\sum }_{k = 1}^{N} {f}_{k} X ( k )$ | kurtosis frequency | ${F}_{5} = \frac{{\sum }_{k = 1}^{N} {( {f}_{k} - {F}_{2} )}^{4} X ( k )}{N {F}_{3}^{4}}$ |
| standard deviation frequency | ${F}_{3} = \sqrt{\frac{1}{N} {\sum }_{k = 1}^{N} {( {f}_{k} - {F}_{2} )}^{2} X ( k )}$ | / | / |

In this embodiment, the eigenvalues of five frequency domain characteristic parameters, such as the average amplitude, the root mean square frequency, the center frequency, the kurtosis frequency and the standard deviation frequency, which are calculated by the formulas defined in Table 3, are saved for analysis and use in the subsequent steps. The average amplitude in frequency domain can reflect the energy of the arc acoustic emission signals to some extent. The central frequency can reflect the position changes of the main frequency band of the arc acoustic emission signals. The standard deviation frequency reflects the scattering degree of the spectrums of the arc acoustic emission signals. The root mean square frequency contains the changing trend of arc stability.

The third step is time-frequency domain analysis.

In this embodiment, a Hilbert-Huang Transform (HHT) is performed on the sample acoustic emission signals, and Hilbert time-frequency diagrams can be drawn. In the Hilbert time-frequency diagrams of the acoustic emission signals, the arc stability in Experimental welding process can be observed through the regularity and color distribution of the frequency along the time axis.

According to the spectrum diagram drawn by the acoustic emission signal of Experiment 1, it can be observed that the frequency distribution is mainly concentrated in 0 to 150 Hz, but there are some chaotic frequency components in the frequency band of 150 to 300 Hz. The signal frequency component corresponding to 1.36 Hz in the pulse frequency diagram has obvious regularity along the time scale. From the color point of view, the energy change of the part of 1 to 3s is stable and continuous, but the color of the part of 3 to 4s is obviously richer and indicating that the change in the signal energy is more intense than at other times. By looking at the welding seam of the actual welding assembly in Experiment 1, it is found that the corresponding welding seam has a broken arc at the formation. According to the spectrum diagram drawn by the acoustic emission signal of Experiment 2, it can be observed that the frequency distribution is scattered mainly in the frequency range of 0 to 1500 Hz. The signal frequency component corresponding to 0.7 Hz in the pulse frequency diagram is not obvious along the time scale. From the color point of view, the signal is very sparse, and the energy distribution is discontinuous. By looking at the welding seam of the actual welding assembly in Experiment 2, the corresponding welding seam has formed an alternating convex and concave phenomenon, which shows that the arc is in an unstable state during welding. Therefore, the stable state of the arc in the welding process can be judged by analyzing time-frequency domain.

In this embodiment, instantaneous attribute and function can be obtained by HHT on the sample acoustic emission signals. For example, if the Hilbert spectrum is H(ω, t), a marginal spectrum h(ω) can be defined on the basis of the Hilbert spectrum as: h(ω)=∂₀^{t}H(ω, t), where t is the signal duration.

In this embodiment, it can be seen from the definition formula of the marginal spectrum that the marginal spectrum is the cumulative quantity of the Hilbert spectrum in frequency, and the marginal spectrum is obtained by integrating the Hilbert spectrum with time. The existence of an energy at a specific frequency in the spectrum means that the signal at that frequency exists in the whole signal duration. In the marginal spectrum, the existence of the energy at a specific frequency means that waves at this frequency are more likely to appear at a specific point in the total duration of the signal. Therefore, the existence of the energy at a specific frequency can be analyzed through the analysis of the marginal spectrum, which means that it is likely to have the response to the frequency. The specific moment when the response appears is shown in the Hilbert spectrum.

Specifically, peak values of three highest spectral peaks of the marginal spectrum can be extracted as the time-frequency domain characteristic parameters, and saved for research and analysis in the subsequent steps.

In this embodiment, the complexity of the acoustic emission signals can also be studied through an information entropy and an multi-scale entropy. When the acoustic emission signal is more complex, it means that the higher the uncertainty of the acoustic emission signal, the lower the arc stability. Moreover, when the acoustic emission signal is less complex, it means that the lower the uncertainty of the acoustic emission signal, the higher the arc stability. Therefore, the information entropy and the sample entropy are taken as entropy characteristic parameters, and the calculated entropy characteristic parameters are saved for analysis and use in the subsequent steps.

The greater the information entropy value, the more complex the acoustic emission signal; the smaller the information entropy, the simpler the acoustic emission signal. The sample entropy can measure the complexity of the acoustic emission signal on the time scale. Because the complexity of the signal is measured on one scale, it is impossible to fully characterize the complexity of the signal on another scale. Therefore, mining the signal entropy value from the multi-scale perspective using the method of the multi-scale sample entropy not only can quantify the complexity of the whole time series, but also extract effective characteristic quantities at multiple scales, so as to judge the complexity of the acoustic emission signal more accurately. Moreover, the multi-scale sample entropy is an improved complexity measurement method with good robustness.

It should be noted that the method of calculating the information entropy and the sample entropy is the prior art, which will not be described in detail here.

In this embodiment, seven time-domain characteristic parameters, such as the mean, the peak, the peak-to-peak value, the root mean square, the variance, the mean square value and the kurtosis coefficient, five frequency domain characteristic parameters, such as the average amplitude, the root mean square frequency, the center frequency, the kurtosis frequency and the standard deviation frequency, three time-domain characteristic parameters of the peak values of three highest spectral peaks of the marginal spectrum, and two entropy characteristic parameters, such as the information entropy and the multi-scale sample entropy, can be taken as the initial indexes for research by analysis of the time domain, the frequency domain and the time-frequency domain of the above two groups of experiments. Finally, the final indexes for evaluating stability is determined from these initial indexes.

In this embodiment, because there are many welding process parameters of DP-MIG welding of aluminum alloys with strong adjustability, the correctness of setting and matching of various welding process parameters will directly affect the stability of the arc in the welding process. Therefore, more experiments are needed to acquire a large number of sample acoustic emission signals. The initial indexes of a large number of sample acoustic emission signals are researched. A plurality of indexes for evaluating arc stability as well as the reference index values of each index and the number of evaluation levels are finally determined.

For example, Table 4 provides another table of experimental process parameters. According to this table of process parameters, repeated experiments are carried out for 20 times for each group of process parameters, totaling 360 groups of welding experiments. More comprehensive sample acoustic emission signals can be acquired. Table 4 is as follows:

TABLE 4

| | | | | Peak | Base | | |
|---|---|---|---|---|---|---|---|
| | Welding | Peak | Base | volt- | volt- | Duty | Pulse |
| | speed | current | current | age | age | cycle | frequency |
| Number | (mm/s) | (A) | (A) | (V) | (V) | (%) | (Hz) |
| 1 | 2.2 | 100 | 40 | 20 | 14 | 40 | 1 |
| 2 | 2.2 | 110 | 45 | 22 | 16 | 50 | 1.5 |
| 3 | 2.2 | 120 | 50 | 24 | 18 | 60 | 2 |
| 4 | 2.4 | 100 | 40 | 22 | 16 | 60 | 2 |
| 5 | 2.4 | 110 | 45 | 24 | 18 | 40 | 1 |
| 6 | 2.4 | 120 | 50 | 20 | 14 | 50 | 1.5 |
| 7 | 2.6 | 100 | 45 | 20 | 18 | 50 | 2 |
| 8 | 2.6 | 110 | 50 | 22 | 14 | 60 | 1 |
| 9 | 2.6 | 120 | 40 | 24 | 16 | 40 | 1.5 |
| 10 | 2.2 | 100 | 50 | 24 | 16 | 50 | 2 |
| 11 | 2.2 | 110 | 40 | 20 | 18 | 60 | 1.5 |
| 12 | 2.2 | 120 | 45 | 22 | 14 | 40 | 2 |
| 13 | 2.4 | 100 | 45 | 24 | 14 | 60 | 1.5 |
| 14 | 2.4 | 110 | 50 | 20 | 16 | 40 | 2 |
| 15 | 2.4 | 120 | 40 | 22 | 18 | 50 | 1 |
| 16 | 2.6 | 100 | 50 | 22 | 18 | 40 | 1.5 |
| 17 | 2.6 | 110 | 40 | 24 | 14 | 50 | 2 |
| 18 | 2.6 | 120 | 45 | 20 | 16 | 60 | 1 |

In this embodiment, the arc acoustic emission signals are adaptively extracted from the sample acoustic emission signals collected by 360 groups of experiments using the same method as the two groups of preliminary research experiments in Table 1 above. Using the principle of calculating the characteristic parameters of the sample acoustic emission signals described above, seven time-domain statistical characteristics of the mean, the peak, the peak-to-peak value, the root mean square, the variance, the mean square value and the kurtosis coefficient of the sample arc acoustic emission signal data are calculated in time domain; five frequency domain features, such as the average amplitude, the root mean square frequency, the center frequency, the kurtosis frequency and the standard deviation frequency, are calculated in frequency domain; the marginal spectrums are obtained by HHT on the signals in time-frequency domain, and the peak-to-peak values of three highest spectral peaks of the marginal spectrums are extracted as three time-frequency domain characteristic parameters. In the entropy feature, the information entropy and the sample entropy of seven scales are calculated. The sample entropies of seven scales are denoted as sample entropy 1, sample entropy 2, sample entropy 3, sample entropy 4, sample entropy 5, sample entropy 6 and sample entropy 7, respectively. Therefore, eight types of entropy characteristic parameters can be obtained. To sum up, 23 types of characteristic parameters can be obtained, and these 23 types of characteristic parameters are used as initial indexes for research.

In this embodiment, the initial indexes can be researched and analyzed by Q-learning algorithm, and finally a plurality of indexes for evaluating arc stability can be determined from the initial indexes.

In this embodiment, the kurtosis coefficient, the standard deviation frequency and the information entropy and sample entropy 1 and sample entropy 2 in the sample entropy in 23 types of initial indexes are finally used as five indexes to evaluate arc stability through Q learning algorithm.

In this embodiment, after 360 groups of welding tests, the welding seam shaping state is divided into four levels according to the actual welding seam shaping state. That is, the arc stability level is divided into four levels.

Optionally, the four evaluation levels include good stability, average stability, poor stability and extremely poor stability.

In this embodiment, according to the evaluation levels and the calculated reference index values of each index, the reference index values are divided into numerical intervals and correspond to the evaluation levels. In other words, an evaluation level corresponds to a numerical interval.

For example, the evaluation levels include four levels, that is, good stability, average stability, poor stability and extremely poor stability. The five indexes for evaluating arc stability include the kurtosis coefficient, the standard deviation frequency, the information entropy, the sample entropy 1 and the sample entropy 2. Thereafter, the reference index values of the five indexes are normalized, and the numerical interval division of the five indexes of the evaluation levels can be expressed as follows:
Vₚₑₐₖ={V_{good}, V_{average}, Vₚₒₒᵣ, V_{extremely poor}}
={(0,0.16),(0.16,0.37),(0.37,0.61),(0.61,1)};
V_{standard}={V_{good}, V_{average}, Vₚₒₒᵣ, V_{extremely poor}}
32 {(0,0.12),(0.12,0.35),(0.35,0.63),(0.63,1)};
V_{information}={V_{good}, V_{average}, Vₚₒₒᵣ, V_{extremely poor}}
={(0,0.09),(0.09,0.31),(0.31,0.59),(0.59,1)};
V_{sample 1}={V_{good}, V_{average}, Vₚₒₒᵣ, V_{extremely poor}}
={(0,0.13),(0.13,0.29),(0.29,0.67),(0.67,1)};
V_{sample 2}={V_{good}, V_{average}, Vₚₒₒᵣ, V_{extremely poor}}
={(0,0.15),(0.15,0.33),(0.33,0.71),(0.71,1)}.

Step S520: reference membership degrees of different indexes to different evaluation levels are determined according to the reference index values of each index.

In this embodiment, because each evaluation index has different influences on the evaluation result, the membership degrees of each evaluation index corresponding to different evaluation levels are determined according to the characteristics of the evaluation indexes by setting membership degree functions.

A membership degree function is used to indicate a degree or weight of specified value belongs to aset. In this embodiment, a membership degree function is used to indicate the degree or weight of a reference index value belongs to a certain evaluation level.

Specifically, according to the influence of each index on arc stability, each evaluation index can be divided into an increasing factor or a decreasing factor. The increasing factor and the decreasing factor indicate that the arc stability increases or decreases with the increase of the index value.

In this embodiment, the sample acoustic emission signals of 360 groups of experiments are calculated to obtain the reference index values and the welding seam states produced by actual welding, so as to obtain the following conclusions.
(1) the kurtosis coefficient can quantitatively describe the steepness of the arc acoustic emission signal curve. The larger the value, the steeper the arc acoustic emission signal curve, and the lower the arc stability.
(2) the standard deviation frequency reflects the scattering degree of the spectrums of the arc acoustic emission signals. The larger the value, the more scattered the spectrums of the arc acoustic emission signals, and the more scattered the signal energy distribution, the lower the arc stability.
(3) the information entropy is a physical quantity to describe the uncertainty of a system. The larger the value, the higher the uncertainty of the arc acoustic emission signals, and the lower the arc stability.
(4) the sample entropy is used to measure the complexity of the time series by measuring the probability that new modes are generated in the arc acoustic emission signals. The larger the value, the higher the complexity of the arc acoustic emission signals, and the lower the arc stability.

Therefore, through the above analysis, it can be seen that the five evaluation indexes are all decreasing factor, and their membership degree functions can be defined as shown in Table 5:

| membership degree function | decreasing factor |
|---|---|
| ${μ}_{{v}_{good} ( {μ}_{i} )} = \{ \begin{matrix}1 \\ 0.5 \times [ 1 + \frac{{u}_{i} - {k}_{1}}{{k}_{1}^{′} - {k}_{1}} ] \\ 0.5 \times [ 1 - \frac{{k}_{1} - {u}_{i}}{{k}_{1} - {k}_{2}^{′}} ] \\ 0\end{matrix}$ | ${μ}_{{v}_{good} ( {μ}_{i} )} = \{ \begin{matrix}{u}_{i} < {k}_{1}^{′} \\ {k}_{1}^{′} \leq {u}_{i} < {k}_{1} \\ {k}_{1} \leq {u}_{i} < {k}_{2}^{′} \\ {u}_{i} \geq {k}_{2}^{′}\end{matrix}$ |
| ${μ}_{{v}_{average} ( {μ}_{i} )} = \{ \begin{matrix}0 \\ 0.5 \times [ 1 - \frac{{u}_{i} - {k}_{1}}{{k}_{1}^{′} - {k}_{1}} ] \\ 0.5 \times [ 1 + \frac{{k}_{1} - {u}_{i}}{{k}_{1} - {k}_{2}^{′}} ] \\ 0.5 \times [ 1 + \frac{{u}_{i} - {k}_{2}}{{k}_{2}^{′} - {k}_{2}} ] \\ 0.5 \times [ 1 - \frac{{k}_{2} - {u}_{i}}{{k}_{2} - {k}_{3}^{′}} ] \\ 0\end{matrix}$ | ${μ}_{{v}_{average} ( {μ}_{i} )} = \{ \begin{matrix}{u}_{i} < {k}_{1}^{′} \\ {k}_{1}^{′} \leq {u}_{i} < {k}_{1} \\ {k}_{1} \leq {u}_{i} < {k}_{2}^{′} \\ {k}_{2}^{′} \leq {u}_{i} < {k}_{2} \\ {k}_{2} \leq {u}_{i} < {k}_{3}^{′} \\ {u}_{i} \geq {k}_{3}^{′}\end{matrix}$ |
| ${μ}_{{v}_{poor} ( {μ}_{i} )} = \{ \begin{matrix}0 \\ 0.5 \times [ 1 - \frac{{u}_{i} - {k}_{2}}{{k}_{2}^{′} - {k}_{2}} ] \\ 0.5 \times [ 1 + \frac{{k}_{2} - {u}_{i}}{{k}_{2} - {k}_{3}^{′}} ] \\ 0.5 \times [ 1 + \frac{{u}_{i} - {k}_{3}}{{k}_{3}^{′} - {k}_{3}} ] \\ 0.5 \times [ 1 - \frac{{k}_{3} - {u}_{i}}{{k}_{3} - {k}_{4}^{′}} ] \\ 0\end{matrix}$ | ${μ}_{{v}_{poor} ( {μ}_{i} )} = \{ \begin{matrix}{u}_{i} < {k}_{2}^{′} \\ {k}_{2}^{′} \leq {u}_{i} < {k}_{2} \\ {k}_{2} \leq {u}_{i} < {k}_{3}^{′} \\ {k}_{3}^{′} \leq {u}_{i} < {k}_{3} \\ {k}_{3} \leq {u}_{i} < {k}_{4}^{′} \\ {u}_{i} \geq {k}_{4}^{′}\end{matrix}$ |
| ${μ}_{{v}_{extremely poor} ( {μ}_{i} )} = \{ \begin{matrix}0 \\ 0.5 \times [ 1 - \frac{{u}_{i} - {k}_{3}}{{k}_{3}^{′} - {k}_{3}} ] \\ 0.5 \times [ 1 + \frac{{k}_{3} - {u}_{i}}{{k}_{3} - {k}_{4}^{′}} ] \\ 0.5 \times [ 1 + \frac{{u}_{i} - {k}_{4}}{{k}_{4}^{′} - {k}_{4}} ] \\ 0\end{matrix}$ | ${μ}_{{v}_{extremely poor} ( {μ}_{i} )} = \{ \begin{matrix}{u}_{i} < {k}_{3}^{′} \\ {k}_{3}^{′} \leq {u}_{i} < {k}_{3} \\ {k}_{3} \leq {u}_{i} < {k}_{4}^{′} \\ {k}_{4}^{′} \leq {u}_{i} < {k}_{4} \\ {u}_{i} \geq {k}_{4}\end{matrix}$ |

k₁, k₂, k₃ and k₄ denote the critical values of the numerical ranges k₁′, k₂′, k₃′ and k₄′ denote the midpoints of the numerical ranges with corresponding evaluation levels of V_{good}, V_{average}, Vₚₒₒᵣ, and V_{extremely poor}. uᵢ denotes an average reference index value of the i-th index, and the average reference index valuecan be calculated according to the formula:

$${u}_{i} = \frac{1}{j} ( {u}_{i 1} + {u}_{i 2} + … + {u}_{i j} ) ,$$

in which j denotes the number of samples in the current numerical range, and uᵢ can be {uₚₑₐₖ, u_{standard}, U_{information}, U_{sample 1}, U_{sample 2}}.

In this embodiment, each reference index value of each index for the membership degree belonging to the corresponding evaluation level can be calculated through the above membership degree functions, and the membership degree of each index to each evaluation level can be determined. For example, according to an average reference index value, the numerical range to which the average reference index value belongs is determined. Subsequently, the average reference index value is brought into the corresponding membership degree function to calculate the membership degree of the average reference index value. In the same way, the membership degrees of the reference index values of different indexes are calculated, so as to obtain the membership degree sample set.

For example, according to the data of the above example, the membership degree sample set is obtained as shown in Table 6 below:

TABLE 6

| reference | reference membership degree | | | | |
|---|---|---|---|---|---|
| index set | μₚₑₐₖ | μ_{standard} | μ_{information} | μ_{sample 1} | μ_{sample 2} |
| Q_{good} | 0.890 | 0.930 | 0.960 | 0.990 | 0.98 |
| Q_{average} | 0.710 | 0.790 | 0.820 | 0.870 | 0.850 |
| Qₚₒₒᵣ | 0.600 | 0.700 | 0.750 | 0.780 | 0.710 |
| Q_{extremely poor} | 0.530 | 0.590 | 0.610 | 0.550 | 0.510 |

Step S530: acoustic emission signals to be measured are acquired.

In this embodiment, the acoustic emission signals to be measured generated in the welding process are acquired.

For example, welding is performed by randomly combined process parameters, and the acoustic emission signals to be measured generated in the welding process are acquired. The specific random process parameters are shown in Table 7 below:

TABLE 7

| | | | | Peak | Base | | Pulse |
|---|---|---|---|---|---|---|---|
| Number | Welding | Peak | Base | volt- | volt- | Duty | fre- |
| to be | speed | current | current | age | age | cycle | quency |
| measured | (mm/s) | (A) | (A) | (V) | (V) | (%) | (Hz) |
| 1 | 2.2 | 120 | 40 | 21 | 17.5 | 50 | 2 |
| 2 | 3 | 130 | 60 | 22 | 15 | 50 | 2 |

According to the process parameters in Table 7, welding is repeated, and each group of experiments to be measured is carried out for 20 times, so that 40 groups of experimental data to be measured can be obtained.

Step S540: an index value to be measured of each index is determined according to the acoustic emission signals to be measured.

In this embodiment, the two groups of collected acoustic emission signals to be measured are extracted adaptively, and then are converted in time domain, frequency domain and time-frequency domain. Thereafter, according to the definition formula of each characteristic parameter in Step S510, the index values to be measured of five indexes can be calculated. Because Experimental data to be measured is the data of 20 repeated experiments, 20 index values to be measured can be calculated, and finally the average value of the 20 index values to be measured is calculated as the index value to be measured for each index.

Step S550: a membership degree to be measured of each index is determined according to the index value to be measured of each index.

In this embodiment, the membership degree to be measured of each index can be obtained, respectively, by substituting the index value to be measured into the membership degree function formula in Table 5. The membership degrees to be measured of each group of experiments to be measured are expressed with a set, which are denoted as the membership degree set to be measured:

Q₁={μₚₑₐₖ¹, μ_{standard}¹, μ_{information}¹, μ_{sample 1}¹, μ_{sample 2}¹};

Q₂={μₚₑₐₖ², μ_{standard}², μ_{information}², μ_{sample 1}², μ_{sample 2}¹}.

It should be noted that the method of calculating the membership degrees to be measured is the same as the method of calculating the reference membership degrees, which will not be described in detail here.

For example, according to the data in the above example, membership degree set to be measured are calculated as shown in Table 8 below:

TABLE 8

| Index set to | membership degrees to be measured | | | | |
|---|---|---|---|---|---|
| be measured | μₚₑₐₖ | μ_{standard} | μ_{information} | μ_{sample 1} | μ_{sample 2} |
| Q₁ | 0.810 | 0.890 | 0.900 | 0.930 | 0.960 |
| Q₂ | 0.680 | 0.600 | 0.690 | 0.570 | 0.620 |

Step S560: a level of the arc stability is evaluated according to membership degrees to be measured and the reference membership degrees.

Optionally, Step S560 includes:
Step 1: determining closeness of the acoustic emission signals to be measured to each evaluation level according to the membership degrees to be measured and the reference membership degrees.

Optionally, Step 1 includes:
determining a weight of each index; determining a Hamming distance of each evaluation level according to the weights, the membership degrees to be measured and the reference membership degrees; determining the closenesses of the acoustic emission signals to be measured to each evaluation level according to the Hamming distance of each evaluation level.

In this embodiment, there are many methods to define the closeness, in which the Euclidean distance and the Hamming distance are commonly used methods. The Hamming distance method has the advantages of clear physical meaning and intuitive relationship between compared quantities. Considering the research object of the present disclosure comprehensively, the Hamming distance is used as the method to determine the closenesses.

Optionally, the Hamming distances can be determined according to the following formula:

$${D}_{i} ( {μ}_{B} , {μ}_{{A}_{i}} ) = m * {\sum }_{k = 1}^{m} [ \vert {μ}_{B} ( {X}_{K} ) - {μ}_{{A}_{i}} ( {X}_{K} ) \vert * {W}_{k} ] ;$$

where Dᵢ denotes the Hamming distance of an i-th level, m denotes the number of indexes, i denotes the number of the evaluation levels, μ_{B} (Xₖ) denotes the membership degree to be measured of a k-th index, μ_{A}_{ᵢ} (Xₖ) denotes the reference membership degree of the k-th index to the i-th level, and Wₖ denotes the weight of the k-th index.

A fuzzy comprehensive evaluation method can be used to determine the weight Wₖ of each index. Specifically, through the fuzzy comprehensive evaluation method, the sample index values of each index is normalized, and the weight of each index is calculated according to the processed sample index values, which can be denoted as W={Wₚₑₐₖ, W_{standard}, W_{information}, W_{sample 1}, W_{sample 2}}.

In this embodiment, the weights of the index values to be measured can be calculated by a nearest neighbor algorithm according to the weight of each index determined above.

Optionally, the closenesses can be determined according to the following formula:

$${σ}_{i} ( {μ}_{B} , {μ}_{{A}_{i}} ) = 1 - \frac{{D}_{i} ( {μ}_{B} , {μ}_{{A}_{i}} )}{m}$$

where σᵢ denotes the closeness of the i-th level, Dᵢ denotes the Hamming distance of the i-th level, m denotes the number of indexes, μ_{B} denotes the membership degrees to be measured, and μ_{A}_{ᵢ} denotes the reference membership degrees under the i-th level.

Step 2: the level of the arc stability is evaluated according to the closenesses.

In this embodiment, the closenesses are σ(Q, Q_{good}), σ(Q, Q_{average}), σ(Q, Qₚₒₒᵣ), σ(Q, Q_{extremely poor}), in which the evaluation level of the membership degree set corresponding to the largest closeness indicates which level the arc stability belongs to. For example, the maximum value of σ(Q, Q_{good}) indicates that the stability level of the arc is good.

For example, the arc stability of Experiment 1 to be measured is good and the arc stability of Experiment 2 to be measured is extremely poor by calculating the data in the above example. The welding seam states formed by actually welding are acquired. The welding seams of Experiment 1 to be measured are well shaped and have beautiful fish scales, while the welding seams of Experiment 2 to be measured are not shaped. Therefore, the arc stability in the welding process of Experiment 1 to be measured is evaluated as good, and the arc stability in the welding process of Experiment 2 to be measured is evaluated as extremely poor, which are consistent with the actual welding seam shaping states of these two groups of experiments.

Based on the same inventive concept, the embodiment of the present disclosure further provides an apparatus for evaluating welding arc stability. FIG. 16 is a structural block diagram of evaluating welding arc stability according to an embodiment of the present disclosure. As shown in FIG. 16, the apparatus 16 includes a first determining module 161, a second determining module 162, an acquiring module 163, a third determining module 164, a fourth determining module 165 and an evaluating module 166.

The first determining module 161 is configured to determine a plurality of indexes for evaluating arc stability, reference index values of each index and a number of evaluation levels according to sample acoustic emission signals.

The second determining module 162 is configured to determine reference membership degrees of different indexes to different evaluation levels according to the reference index values of each index.

The acquiring module 163 is configured to acquire acoustic emission signals to be measured.

The third determining module 164 is configured to determine an index value to be measured of each index according to the acoustic emission signals to be measured.

The fourth determining module 165 is configured to determine a membership degree to be measured of each index according to the index value to be measured of each index.

The evaluating module 166 is configured to evaluate a level of the arc stability according to membership degrees to be measured and the reference membership degrees.

Optionally, the evaluating module 166 includes:
a closeness determining unit, which is configured to determine the closenesses of the acoustic emission signals to be measured to each evaluation level according to the membership degrees to be measured and the reference membership degrees; and
a level evaluation unit, which is configured to evaluate the level of the arc stability according to the closenesses.

Optionally, the closeness determining unit is further configured to:
determine a weight of each index;
determine a Hamming distance of each evaluation level according to the weights, the membership degrees to be measured and the reference membership degrees; and
determine the closenesses of the acoustic emission signals to be measured to each evaluation level according to the Hamming distance of each evaluation level.

Optionally, the closeness determining unit is further configured to:
determine the Hamming distances according to the following formula:

$${D}_{i} ( {μ}_{B} , {μ}_{{A}_{i}} ) = m * {\sum }_{k = 1}^{m} [ \vert {μ}_{B} ( {X}_{K} ) - {μ}_{{A}_{i}} ( {X}_{K} ) \vert * {W}_{k} ]$$

where Dᵢ denotes the Hamming distance of an i-th level, m denotes the number of indexes, i denotes the number of the evaluation levels, μ_{B} (Xₖ) denotes the membership degree to be measured of a k-th index, μ_{A}_{ᵢ}(Xₖ) denotes the reference membership degree of the k-th index to the i-th level, and Wₖ denotes the weight of the k-th index.

Optionally, the closeness determining unit is further configured to:
determine the closenesses according to the following formula:

$${σ}_{i} ( {μ}_{B} , {μ}_{{A}_{i}} ) = 1 - \frac{{D}_{i} ( {μ}_{B} , {μ}_{{A}_{i}} )}{m}$$

where σᵢ denotes the closeness of the i-th level, Dᵢ denotes the Hamming distance of the i-th level, m denotes the number of indexes, μ_{B} denotes the membership degrees to be measured, and μ_{A}_{ᵢ} denotes the reference membership degrees under the i-th level.

Optionally, the first determining module 161 is further configured to:
determine a plurality of indexes for evaluating arc stability by analyzing the sample acoustic emission signals in time domain, frequency domain and time-frequency domain.

Optionally, there are four evaluation levels, that is, good stability, average stability, poor stability and extremely poor stability.

It can be understood that the apparatus provided in the above embodiment is only illustrated by the division of the above functional modules. In practical application, the above functional allocation can be completed by different functional modules as required, that is, the internal structure of the apparatus is divided into different functional modules to complete all or part of the functions described above.

The embodiment of the present disclosure further provides an electronic device, including a memory and a processor, where the memory and the processor can be in communication connection with each other through a bus or other means.

The processor may be a Central Processing Unit (CPU), or an Application Specific Integrated Circuit (ASIC), or may be configured to one or more integrated circuits to implement the embodiments of the present disclosure.

The memory may include a mass memory for data or instructions. By way of example and not limitation, the memory may include a Hard Disk Drive (HDD), a floppy disk drive, a flash memory, an optical disk, a magneto-optical disk, a magnetic tape or a Universal Serial Bus (USB) drive or a combination of two or more thereof. Where appropriate, the memory may include removable or non-removable (or fixed) media. Where appropriate, the memory may be internal or external to the electronic device. In a particular embodiment, the memory may be a non-volatile solid-state memory.

In an example, the memory may be a Read Only Memory (ROM). In an example, the ROM may be a mask programmed ROM, a programmable ROM (PROM), an erasable PROM (EPROM), an electrically erasable PROM (EEPROM), an electrically rewritable ROM (EAROM) or a flash memory or a combination of two or more thereof.

The processor reads and executes the computer program instructions stored in the memory to implement any one of the method for evaluating welding arc stability in the above embodiments.

In an example, the electronic device may further include a communication interface and a bus. The processor, the memory and the communication interface are connected through the bus and are in communication with each other. The communication interface is mainly configured to implement the communication between modules, apparatuses, units and/or devices in the embodiment of the present disclosure. Where appropriate, the bus may include one or more buses.

In addition, the embodiment of the present disclosure can provide a computer-readable storage medium in combination with the method for evaluating welding arc stability in the above embodiment. The computer-readable storage medium stores computer instructions; and the computer program instructions, when executed by a processor, implement any one of the method for evaluating welding arc stability in the above embodiments.

The above technical solution in the embodiment of the present disclosure has at least the following technical effects or advantages:

The embodiment of the present disclosure provides a method and an apparatus for evaluating welding arc stability, a device and a medium, in which a plurality of indexes for evaluating arc stability, reference index values of each index and a number of evaluation levels are determined according to sample acoustic emission signals, that is to say, a complex physical welding process is reflected through acoustic emission signals; reference membership degrees of different indexes to different evaluation levels are determined according to the reference index values of each index, and the degree to which an index belongs to an evaluation level can be accurately judged through the membership degree; the index value to be measured of each index is determined according to the acquired acoustic emission signals to be measured; the membership degree to be measured of each index is determined according to the index value to be measured of each index; and the level of the arc stability is evaluated according to the membership degrees to be measured and the reference membership degrees. The method reflects a complex physical welding process through the detected acoustic emission signals generated in the welding process, and then evaluates the level of the arc stability by means of the membership degrees, so that the evaluation result is more accurate. The welding process is adjusted with reference to the evaluation level, which can effectively suppress the defects in the welding process and improve the quality of the welding structure.

In the description provided here, numerous specific details are set forth. However, it is to be understood that embodiments of the present disclosure may be practiced without these specific details. In some instances, well-known methods, structures and techniques have not been shown in detail so as not to obscure the understanding of the specification.

Similarly, it should be understood that in the above description of the exemplary embodiments of the present disclosure, various features of the present disclosure are sometimes grouped together into a single embodiment, figure, or description thereof, in order to simplify the present disclosure and help to understand one or more aspects of the present disclosure. However, the provided method should not be interpreted as reflecting the intention that the claimed present disclosure requires more features than those explicitly recited in each claim. Rather, as reflected in the following claims, the aspect of the present disclosure lies in less than all features of a single embodiment provided previously. Therefore, the claims following the detailed description of the embodiments are hereby expressly incorporated into the detailed description of the embodiments, where each claim stands as a separate embodiment of the present disclosure.

It should be noted that the above embodiments illustrate the present disclosure, rather than limit the present disclosure, and those skilled in the art can design alternative embodiments without departing from the scope of the appended claims. In the claims, any reference numerals placed between parentheses shall not be constructed as limitations on the claims. The word “including” does not exclude the presence of components or steps not listed in a claim. The word “a” or “an” preceding a component does not exclude the existence of a plurality of such components. The present disclosure can be implemented by means of hardware including several different components and by means of a suitably programmed computer. In the unit claim enumerating several apparatuses, several of these apparatuses can be embodied by the same hardware. The use of the words “first”, “second”, and “third” does not indicate any order. These words can be interpreted as names.

What is claimed is:

1. A method for evaluating welding arc stability, the method comprising:
determining a plurality of indexes for evaluating arc stability, reference index values of each index and a number of evaluation levels according to sample acoustic emission signals;
determining reference membership degrees of different indexes to different evaluation levels according to the reference index values of each index;
acquiring acoustic emission signals to be measured;
determining an index value to be measured of each index according to the acoustic emission signals to be measured;
determining a membership degree to be measured of each index according to the index value to be measured of each index; and
evaluating a level of the arc stability according to membership degrees to be measured and the reference membership degrees.

2. The method according to claim 1, wherein evaluating the level of the arc stability according to the membership degrees to be measured and the reference membership degrees comprises:
determining closenesses of the acoustic emission signals to be measured to each evaluation level according to the membership degrees to be measured and the reference membership degrees;
evaluating the level of the arc stability according to the closenesses.

3. The method according to claim 2, wherein determining the closenesses of the acoustic emission signals to be measured to each evaluation level according to the membership degrees to be measured and the reference membership degrees comprises:
determining a weight of each index;
determining a Hamming distance of each evaluation level according to weights, the membership degrees to be measured and the reference membership degrees;
determining the closenesses of the acoustic emission signals to be measured to each evaluation level according to the Hamming distance of each evaluation level.

4. The method according to claim 3, wherein determining the Hamming distance of each evaluation level according to the weights, the membership degrees to be measured and the reference membership degrees comprises:
determining the Hamming distance according to the following formula:
$${D}_{i} ( {μ}_{B} , {μ}_{{A}_{i}} ) = m * {\sum }_{k = 1}^{m} [ \vert {μ}_{B} ( {X}_{K} ) - {μ}_{{A}_{i}} ( {X}_{K} ) \vert * {W}_{k} ] ;$$
wherein Dᵢ denotes the Hamming distance of an i-th level, m denotes a number of indexes, i denotes a number of the evaluation levels, μ_{B} (Xₖ) denotes the membership degree to be measured of a k-th index, μ_{A}_{ᵢ}(Xₖ) denotes the reference membership degree of the k-th index to the i-th level, and Wₖ denotes the weight of the k-th index.

5. The method according to claim 3, wherein determining the closenesses of the acoustic emission signals to be measured to each evaluation level according to the Hamming distance of each evaluation level comprises:
determining the closenesses according to the following formula:
$${σ}_{i} ( {μ}_{B} , {μ}_{{A}_{i}} ) = 1 - \frac{{D}_{i} ( {μ}_{B} , {μ}_{{A}_{i}} )}{m}$$
wherein σᵢ denotes the closeness of the i-th level, Dᵢ denotes the Hamming distance of the i-th level, m denotes a number of indexes, μ_{B} denotes the membership degrees to be measured, and μ_{A}_{ᵢ} denotes the reference membership degrees under the i-th level.

6. The method according to claim 1, wherein determining the plurality of indexes for evaluating arc stability according to the sample acoustic emission signals comprises:
determining the plurality of indexes for evaluating arc stability by analyzing the sample acoustic emission signals in time domain, frequency domain and time-frequency domain.

7. The method according to claim 1, wherein there are four evaluation levels comprising good stability, average stability, poor stability and extremely poor stability.

8. An apparatus for evaluating welding arc stability, the apparatus comprising:
a first determining module, configured to determine a plurality of indexes for evaluating arc stability, reference index values of each index and a number of evaluation levels according to sample acoustic emission signals;
a second determining module, configured to determine reference membership degrees of different indexes to different evaluation levels according to the reference index values of each index;
an acquiring module, configured to acquire acoustic emission signals to be measured;
a third determining module, configured to determine an index value to be measured of each index according to the acoustic emission signals to be measured;
a fourth determining module, configured to determine a membership degree to be measured of each index according to the index value to be measured of each index; and
an evaluating module, configured to evaluate a level of the arc stability according to membership degrees to be measured and the reference membership degrees.

9. An electronic device, comprising a memory and a processor, wherein the memory and the processor are in communication connection with each other, computer instructions are stored in the memory, and the processor executes the method according to claim 1 by executing the computer instructions.
